(19) United States
(12) Patent Application Publication
(10) Pub. No.: US 2019/0178972 A1
(43) Pub. Date: Jun. 13, 2019

(54) DETERMINING ANGLE OF ARRIVAL OF A RADIO-FREQUENCY SIGNAL

(71) Applicant: Cypress Semiconductor Corporation, San Jose, CA (US)

(72) Inventor: Victor Simileysky, San Jose, CA (US)

(73) Assignee: Cypress Semiconductor Corporation, San Jose, CA (US)

(21) Appl. No.: 15/938,452

(22) Filed: Mar. 28, 2018

Related U.S. Application Data
(60) Provisional application No. 62/598,323, filed on Dec. 13, 2017.

(51) Int. Cl. G01S 3/48; G01S 3/04

(52) U.S. Cl. CPC G01S 3/48; G01S 3/043

(57) ABSTRACT

An apparatus includes a first antenna and a second antenna. A solid dielectric material is disposed between the first antenna and the second antenna. The solid dielectric material may alter radio-frequency signals received by the first antenna or the second antenna by reducing the propagation speed of the radio-frequency signals. This allows the angle of arrival of the radio-frequency signals to be determined.

### CROSS-REFERENCE TO RELATED APPLICATIONS

This application claims the benefit of U.S. Provisional Application No. 62/598,323 filed on Dec. 13, 2017, the entire contents of which are hereby incorporated by reference.

### BACKGROUND

Computing devices may communicate with each other via networks, such as wireless network (e.g., Wi-Fi networks, Bluetooth networks, etc.). A computing device may communicate with another device (e.g., another computing device) in the wireless network by transmitting radio-frequency signals to the other device and by receiving radio-frequency signals from the other device.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an example system architecture, in accordance with some embodiments of the present disclosure.

FIG. 2A illustrates an example computing device, in accordance with some embodiments of the present disclosure.

FIG. 2B illustrates an example computing device, in accordance with some embodiments of the present disclosure.

FIG. 2C illustrates an example receiver component, in accordance with some embodiments of the present disclosure.

FIGS. 3A through 3H illustrate example antenna clusters, in accordance with some embodiments of the present disclosure.

FIG. 4 is a flow diagram of a method of determining an angle of arrival, in accordance with some embodiments of the present disclosure.

FIG. 5 illustrates an example computing device in accordance with some embodiments of the present disclosure.

FIG. 6 is a graph illustrating example phase differences in accordance with some embodiments of the present disclosure.

FIG. 7 is a block diagram of an example device that may perform one or more of the operations described herein, in accordance with some embodiments of the present disclosure.

### DETAILED DESCRIPTION

Computing devices may communicate with each other via networks, such as wireless network (e.g., Wi-Fi networks, Bluetooth networks, etc.). A computing device may communicate with another device (e.g., another computing device) in the wireless networks by transmitting radio-frequency signals to the other device and by receiving radio-frequency signals from the other device. It may be useful for a computing device to determine the direction of the source of a radio-frequency signal, relative to the computing device. For example, determining the direction of a radio-frequency signal may allow the computing device to perform beamforming operations, functions, methods, etc., which may allow the computing device to transmit or receive radio-frequency signals more efficiently. In another example, the direction of a radio-frequency signal may be used for navigational purposes (e.g., to navigate a device towards the source of the radio-frequency signal or in some other direction relative to the direction of the radio-frequency signal). Determining the direction of a radio-frequency signal may be used in, for example and not limitation, asset/object tracking, gaming, networking, navigation applications, and/or Internet of Things (IoT) applications, including industrial, consumer, and automobile applications. The direction of a radio-frequency signal may also be referred to as the angle-of-arrival (AoA) of the radio-frequency signal.

The examples, implementations, and embodiments described herein may use a solid dielectric material to alter a radio-frequency signal by reducing (e.g., decreasing) the propagation speed of the radio-frequency signal by a determined amount. In one embodiment, slowing down the propagation speed of the radio-frequency signal using the dielectric material may allow the computing device to increase directional resolution or the directional precision when determining the angle of arrival of the radio-frequency signal without increasing the distance between antennas in an antenna cluster. This may allow for a reduction in the size of antenna clusters which may allow the antenna cluster to be used in more types of devices and in more applications. In another embodiment, slowing down the propagation speed of the radio-frequency signal using the dielectric material may allow for better (e.g., improved) directional precision or directional resolution without increasing the size of an antenna cluster.

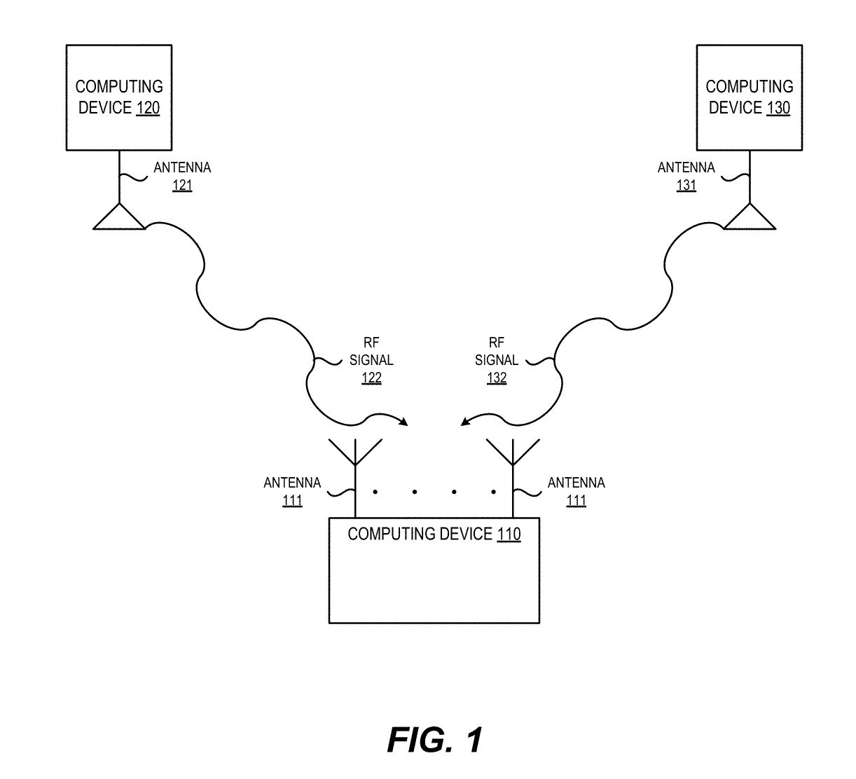

FIG. 1 illustrates an example system architecture 100, in accordance with some embodiments of the present disclosure. The system architecture 100 includes a computing device 110, a computing device 120, and a computing device 130. Each of the computing devices 110, 120, and 130 may include hardware such as processing devices (e.g., processors, central processing units (CPUs), memory (e.g., random access memory (RAM), storage devices (e.g., hard-disk drive (HDD), solid-state drive (SSD), etc.), and other hardware devices (e.g., sound card, video card, etc.). The computing devices 110, 120, and 130 may comprise any suitable type of computing device or machine that has a programmable processor including, for example, server computers, desktop computers, laptop computers, tablet computers, smartphones, personal digital assistants (PDAs), set-top boxes, etc. In some examples, the computing device 110 may comprise a single machine or may include multiple interconnected machines (e.g., multiple servers configured in a cluster). The computing devices 110, 120, and 130 may execute or include an operating system (OS). The OS of the computing devices 110, 120, and 130 may manage the execution of other components (e.g., software, applications, etc.) and/or may manage access to the hardware (e.g., processors, memory, storage devices etc.) of the computing device.

The computing devices 110, 120, and 130 may communicate with each other via a network, such as a wireless network (not illustrated in the figures). The network may be a public network (e.g., the internet), a private network (e.g., a local area network (LAN) or wide area network (WAN)), or a combination thereof. In one embodiment, network may include a wireless infrastructure, which may be provided by one or more wireless communications systems, such as a wireless fidelity (Wi-Fi) access point or hotspot, connected with the network and/or a wireless carrier system that can be implemented using various data processing equipment, communication towers (e.g. cell towers), etc. In other embodiments, the network may be a personal area network, such as a Bluetooth network, a ZigBee network, a Z-Wave network, etc. The network may carry communications (e.g., data, message, packets, frames, etc.) between computing devices 110, 120, and 130.

Computing device 110 includes a set of antennas 111 (e.g., one or more antennas 111). The number of antennas 111 may vary in different embodiments of the present disclosure (e.g., computing device 110 may have two antennas 111, six antennas 111, or some other appropriate number of antennas). The set of antennas 111 may be referred to as an antenna cluster. The set of antennas 111 may be coupled to each other via switching or multiplexing components (e.g., circuits, wires, traces, pins, etc.). Computing device 120 includes an antenna 121 and computing devices 130 includes an antenna 131. Although one antenna 121 and one antenna 131 are illustrated in FIG. 1, the computing devices 120 and 130 may include any appropriate number of antennas 121 and 131, respectively, in other embodiments.

The computing device 120 may communicate with the computing device 110 by transmitting a radio-frequency (RF) signal 122 to the computing device 110 via antenna 121. The computing device 110 may receive the radio-frequency signal 122 via the set of antennas 111. The computing devices 130 may communicate with the computing device 110 by transmitting a radio-frequency signal 132 to the computing device 110 via antenna 131. The computing device 110 may receive the radio-frequency signal 132 via the set of antennas 111. As illustrated in FIG. 1, the computing device 120 is located at a position that is to the left of the computing device 110 and the computing device 130 is located at a position that is to the right of the computing device 110.

In some embodiments, it may be useful for the computing device 110 to determine the direction of the computing devices 120 and 130, relative to the computing device 110 (e.g., to determine the direction or location of the computing devices 120 and 130). For example, it may be useful for the computing device 110 to determine that the computing devices 120 is to the left of the computing device 110, and thus the radio-frequency signal 122 transmitted by the computing device 120 will arrive at the computing device 110 from the left of the computing device 110. In another example, it may be useful for the computing device 110 to determine that the computing devices 130 is to the right of the computing device 110, and thus the radio-frequency signal 132 transmitted by the computing device 130 will arrive at the computing device 110 from the right of the computing device 110. Determining the direction of a radio-frequency signal (e.g., radio-frequency signal 122 or 132) may allow the computing device 110 to perform beamforming operations, functions, methods, etc., which may allow the computing device 110 to transmit or receive radio-frequency signals more efficiently. In another example, the direction of a radio-frequency signal may be used for navigational purposes (e.g., to navigate a device towards the source of the radio-frequency signal or in some other direction relative to the radio-frequency signal).

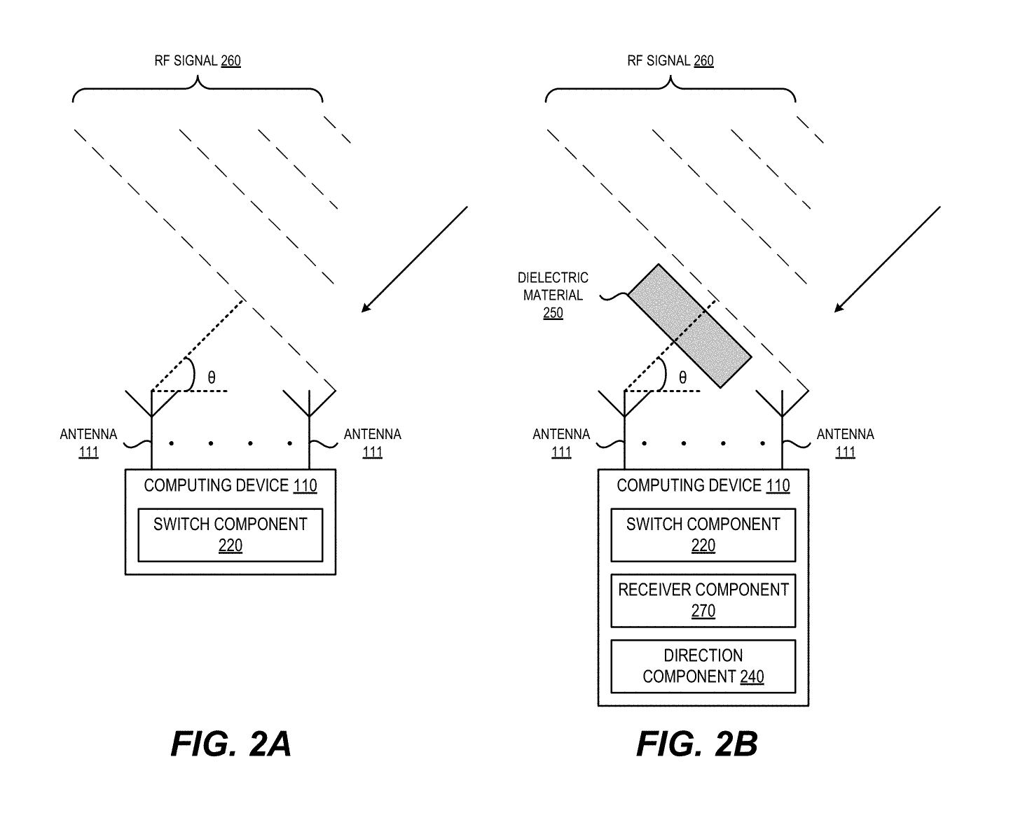

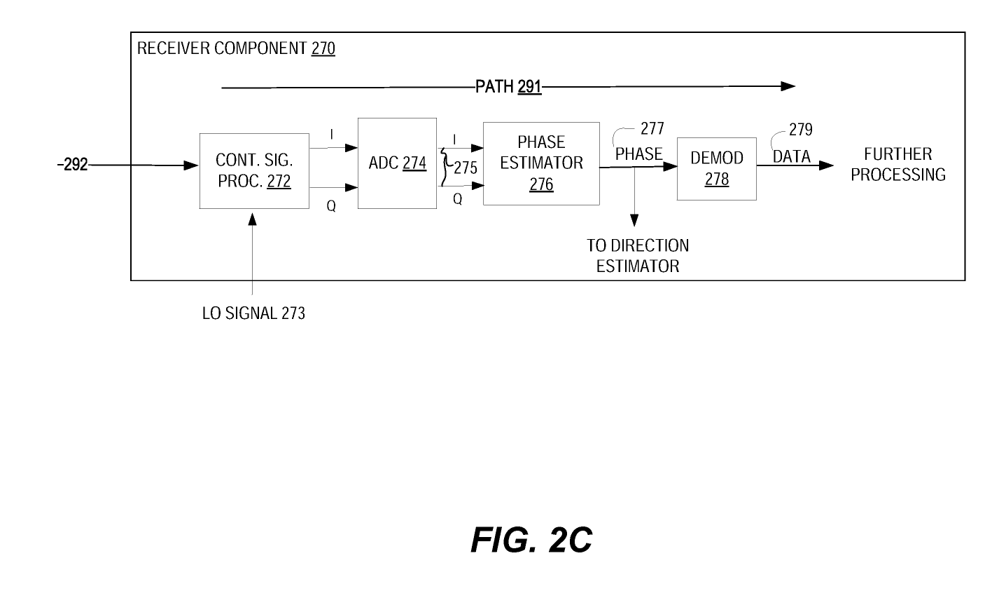

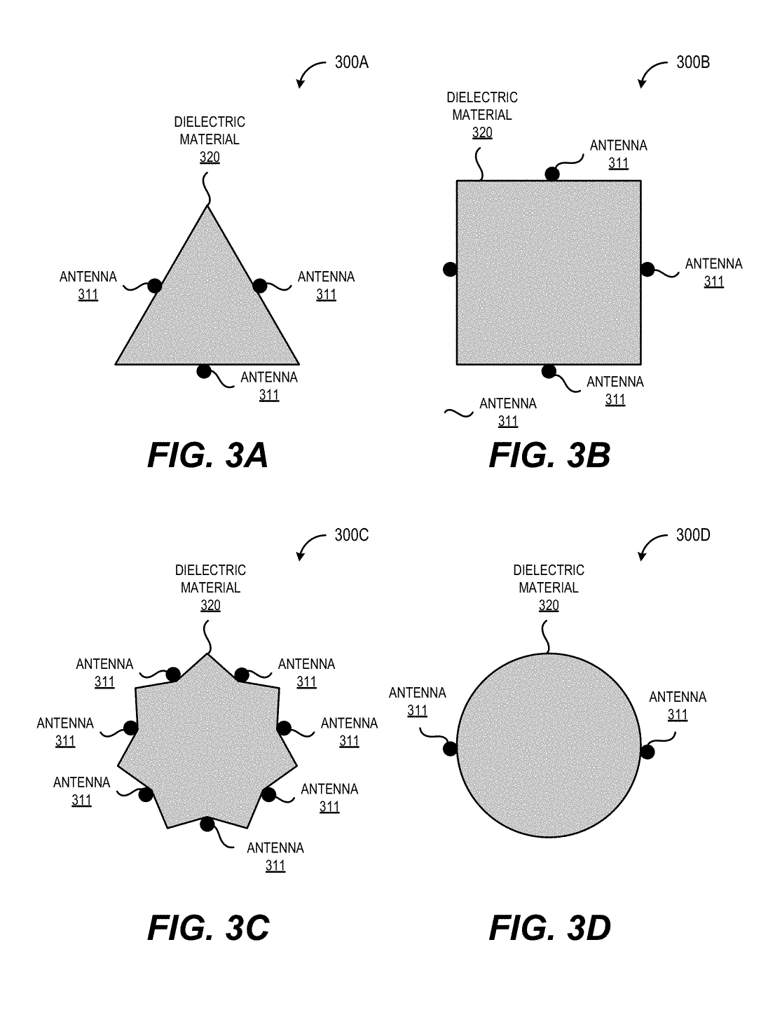

FIG. 2A illustrates an example computing device 110, in accordance with some embodiments of the present disclosure. As discussed above, the computing device 110 may include hardware such as processing devices, memory, storage devices, and other hardware devices. The computing device 110 may comprise any suitable type of combination of devices or machines that has a programmable processor including, for example, server computers, desktop computers, laptop computers, tablet computers, smartphones, personal digital assistants (PDAs), set-top boxes, etc. The computing device 110 may communicate with other devices (e.g., other computing devices or other electronic devices) via a network, such as a wireless network (not illustrated in the figures). The network may carry communications (to and from the computing device 110 via radio-frequency signals, as discussed above.

As illustrated in FIG. 2A, computing device 110 includes a set of antennas 111 (e.g., one or more antennas 111). The number of antennas 111 may vary in different embodiments of the present disclosure (e.g., computing device 110 may have two antennas 111, six antennas 111, or some other appropriate number of antennas). The set of antennas 111 may be referred to as an antenna cluster. The set of antennas 111 may be coupled to each other via switching or multiplexing components. As discussed above, a computing device (or other device) may communicate with the computing device 110 by transmitting a radio-frequency (RF) signal 260 to the computing device 110. The computing device 110 may receive the radio-frequency signal 260 via the set of antennas 111 (e.g., via the antenna cluster). The radio-frequency signal 260 may be transmitted to the computing device 110 as radio waves (illustrated by the dash lines of the radio-frequency signal 260). Examples of radio-frequency signal 260 may be Bluetooth signals, ZigBee signals, Wi-Fi signals, etc.

The computing device 110 also includes a switching component 220. The switching component 220 couples the set of antennas 111 to the receiver component 270. The receiver component 270 may include one or more receivers (e.g., one or more radio receivers). The computing device 110 may also include multiple receiver components in other embodiments. The switching component 220 may couple one antenna to a single receiver or receiver component at a time (e.g., the switching component 220 may rotate between multiple antennas and couple one antenna to the receiver component 270 at a time). In another example, the switching component 220 may couple multiple antennas to a single receiver or receiver component at a time (e.g., the switching component 220 may couple two or more antennas to a receiver component 270 at a time). In a further example, the switching component 220 may couple one antenna to a first receiver or receiver component, and may couple multiple antennas to a second receiver or receiver component. The switching component 220 may be any appropriate coupling or multiplexing circuitry known in the art whose switching, multiplexing, and/or selection function may be controlled by any block coupled to its input.

The angle of arrival (AoA) of the radio-frequency signal 260 (e.g., direction of the source of the radio-frequency signal 260) may be determined using the following equation:

ΔΨ=cos(θ)*D*2π*(F/V_{c}) (1)

where ΔΨ is phase difference between the radio-frequency signal 260 that is received at a first antenna 111 and a second antenna 111, where θ is the angle of arrival of the radio-frequency signal 260, where D is the distance between the first antenna and the second antenna, where F is the frequency of the radio-frequency signal 260, and where V_{c} is the propagation speed of the radio-frequency signals 260 (e.g., the radio wave) through a vacuum. Thus, determining the angle of arrival or direction of a radio-frequency signal 260 may be based on the phase difference (e.g., the signal differentiation) between the radio-frequency signal 260 that is received by the first antenna 111 and the radio-frequency signal 260 that is received by the second antenna 111. For example, the angle of arrival, angle of departure, or direction of the source of the radio-frequency signal 260 may be determined based on the phase difference (e.g., the phase shift) of the radio-frequency signal 260 observed between the first antenna and the second antenna.

As discussed above, it may be useful for the computing device 110 to determine the direction of a source of the radio-frequency signal 260 (e.g., a computing device or other device, which is transmitting or emitting the radio-frequency signal 260). As discussed above, determining the direction of the source of the radio-frequency signal 260 may be referred to as determining the angle of arrival of the radio-frequency signal 260 at the computing device 110, or may be referred to as determining the angle of departure at the source of the radio-frequency signal 260.

One technique for improving the resolution (e.g., directional resolution) or precision (e.g., directional precision) when determining the direction or angle of arrival, the angle of departure, or the direction of a source of the radio-frequency signal 260, may be to increase the distance between the antennas or to increase the number of antennas in an antenna cluster. For example, a larger distance of twenty centimeters (cm) between the first antenna and the second antenna may allow the direction of the source or the angle of arrival of the radio-frequency signal 260 to be determined with sufficient precision. However, larger distances between antennas may increase the size of the antenna cluster which may restrict or limit the places where the antenna cluster may be used. For example, while a distance of twenty centimeters may allow the antenna cluster to be used on an automobile or in industrial applications, but that distance may prevent the antenna cluster from being used in a mobile device (e.g., a smartphone, a tablet computer, a laptop computer, etc.

Other techniques for improving the resolution (e.g., directional resolution) or precision (e.g., directional precision) when determining the direction or angle of arrival, the angle of departure, or the direction of a source of the radiofrequency signal 260 may include using additional components such as low noise amplifiers (LNAs), analog-to-digital converters (ADCs), gain equalizers, etc. However, these additional components may increase the cost of computing devices (e.g., cost to manufacture computing devices) and may increase the complexity of the computing devices (which may increase the failure or malfunction rates of the computing devices).

FIG. 2B illustrates an example computing device 110, in accordance with some embodiments of the present disclosure. As discussed above, the computing device 110 may include hardware such as processing devices, memory, storage devices, and other hardware devices. The computing device 110 may comprise any suitable type of combination of devices or machines that has a programmable processor including, for example, server computers, desktop computers, laptop computers, tablet computers, smartphones, personal digital assistants (PDAs), set-top boxes, etc. The computing device 110 may communicate with other devices (e.g., other computing devices or other electronic devices) via a network, such as a wireless network (not illustrated in the figures). The network may carry communications to and from the computing device 110 via radio-frequency signals, as discussed above. The computing device includes a direction component 240. The direction component 240 may be hardware, software, firmware, or a combination thereof, that may determine the angle of arrival, angle of departure, or direction of a source of a radio-frequency signal, as discussed in more detail below.

As illustrated in FIG. 2B, computing device 110 includes a set of antennas 111 (e.g., an antenna cluster). The number of antennas 111 may vary in different embodiments of the present disclosure. The set of antennas 111 may be referred to as an antenna cluster. The set of antennas 111 may be coupled to each other via switching or multiplexing components. As discussed above, a computing device (or other device) may communicate with the computing device 110 by transmitting a radio-frequency (RF) signal 260 to the computing device 110. The computing device 110 may receive the radio-frequency signal 260 via the set of antennas 111 (e.g., via the antenna cluster). The radio-frequency signal 260 may be transmitted to the computing device 110 as radio waves (illustrated by the dash lines of the radio-frequency signal 260).

As discussed above, it may be useful for the computing device 110 to determine the direction of a source of the radio-frequency signal 260 (e.g., a computing device or other device, which is transmitting or emitting the radio-frequency signal 260). Determining the direction of the source of the radio-frequency signal 260 may be referred to as determining the angle of arrival of the radio-frequency signal 260 at the computing device 110, or may be referred to as determining the angle of departure at the source of the radio-frequency signal 260.

As illustrated in FIG. 2B, a dielectric material 250 is located (e.g., positioned, disposed, placed, etc.), between the radio-frequency signal 260 and the leftmost antenna 111. Thus, the radio-frequency signal 260 may pass through the dielectric material 250 before it is received or detected by the leftmost antenna 111. The dielectric material 250 may be a solid dielectric material (e.g., may be a solid). The angle of arrival of the radio-frequency signal 260 (e.g., direction of the source of the radio-frequency signal 260) which passes through the dielectric material 250 may be determined using the following equation:

ΔΨ=cos(θ)*D*2π*(F/V_{d}) (2)

where ΔΨ is phase difference between the radio-frequency signal 260 that is received at a first antenna 111 and a second antenna 111, where θ is the angle of arrival of the radio-frequency signal 260, where D is the distance between the first antenna and the second antenna, where F is the frequency of the radio-frequency signal 260, and where V_{d} is the propagation speed of the radio-frequency signals 260 (e.g., the radio wave) through a dielectric material. V_{d} may be determined using the following equation:

V_{d}=V_{c}/\sqrt{εᵣ} (3)

where V_{c} is the propagation speed of the radio-frequency signal 260 (e.g., the radio wave) through a vacuum and where εᵣ is the dielectric constant of the dielectric material 250. The dielectric constant of the dielectric material 250 (e.g., εᵣ) may also be referred to as the relative permittivity of the dielectric material 250.

In one embodiment, the propagation speed of the radio-frequency signal 260 as it travels (e.g., passes) through the dielectric material 250 may be reduced or decreased (when compared to the propagation speed of the radio-frequency signal 250 as it travels through a vacuum). For example, the dielectric material 250 may slow down the radio-frequency signal 260 by a certain amount. The amount by which the radio-frequency signal 260 is slowed (e.g., the reduction in the speed of the radio-frequency signal 260) may be determined based on the type of the dielectric material. For example, different dielectric materials (e.g., glass, rubber, graphite, etc.) may slow or reduce the propagation speed of the radio-frequency signal by different amounts. The amount of reduction in the propagation speed may be determined based on predetermined information about one or more of the type of the dielectric material 260, the dielectric constant of the dielectric material 260, and the frequency of the radio-frequency signal. For example, the direction component 240 may have predetermined information or data that indicates of one or more dielectric constants for one or more different types of dielectric material. For example, the direction component 240 may have access to all or portions of Table 1 illustrated below. Table 1 provides non-limiting examples of different dielectric materials (e.g., different types of dielectric material) and their respective dielectric constants. The direction component 240 may be aware of the type of dielectric material 260 that is used (e.g., graphite, rubber, Pyrex, etc.) and may be able to determine the dielectric constant of the dielectric material 260 based on the predetermined information or data.

TABLE 1

| Material Type | Dielectric Constant (εᵣ) |
|---|---|
| Vacuum | 1 (by definition) |
| Air | 1.00058986 |
| PTFE/Teflon | 2.1 |
| Polyethylene/XLPE | 2.25 |
| Polyimide | 3.4 |
| Polypropylene | 2.2-2.36 |
| Polystyrene | 2.4-2.7 |
| Carbon disulfide | 2.6 |
| Mylar | 3.1 |
| Paper | 3.85 |
| Electroactive | 2-12 |
| polymers | |
| Mica | 6-Mar |
| Calcium copper | >250,000 |
| titanate | |
| Silicon dioxide | 3.9 |
| Sapphire | 8.9-11.1 |
| Concrete | 4.5 |
| Pyrex (Glass) | 4.7 (3.7-10) |
| Neoprene | 6.7 |
| Rubber | 7 |
| Diamond | 5.5-10 |
| Salt | 3-15 |
| Graphite | 10-15 |
| Silicon | 11.68 |
| Silicon nitride | 8-Jul |
| Ammonia | 17-26 |
| Conjugated polymers | 1.8-6 up to 100,000 |
| Methanol | 30 |
| Ethylene glycol | 37 |
| Furfural | 42 |
| Glycerol | 41.2, 47, 42.5 |
| Water | 88, 80.1, 55.3, 34.5 |
| Hydrofluoric acid | 175, 134, 111, 83.6 |
| Hydrazine | 52.0 (20° C.), |
| Formamide | 84.0 (20° C.) |
| Sulfuric acid | 84-100 |
| Titanium dioxide | 86-173 |
| Strontium titanate | 310 |
| Barium strontium | 500 |
| titanate | |
| Barium titanate^{[7]} | 1200-10,000 |
| Lead zirconate | 500-6000 |
| titanate | |

In one embodiment, a first antenna 111 and a second antenna 111 may receive the radio-frequency signal 260. The first antenna 111 may be located a first distance (e.g., an actual or physical distance) from the second antenna 111 (e.g., may be located a millimeter a centimeter, or some other appropriate distance from the second antenna 111). The direction component 240 may determine a phase difference in the radio-frequency signal 260 that is received by a first antenna 111 and a second antenna 111, based on one or more of the type of the dielectric material 250 and the dielectric constant of the dielectric material 250. For example, the direction component 240 may determine the type of the dielectric material 250. Based on the type of the dielectric material 250 (e.g., glass, rubber, etc.), the direction component 240 may determine the dielectric constant for the dielectric material 250. In another example, the dielectric constant of the dielectric material 250 may be indicated in a configuration, setting, or parameter stored on the computing device 110 (e.g., may be indicated in a configuration file or setting of the computing device 111).

In some embodiments, the dielectric material 250 may alter the radio-frequency signal 260 by reducing, decreasing, etc., the propagation speed of the radio-frequency signal as it passes through the dielectric material 250. This may allow the antenna cluster (e.g., the set of antennas 111) to simulate or emulate a second distance between the first antenna and the second antenna. The second distance (e.g., the simulated distance) may be larger than the first distance (e.g., the actual or physical distance between the first antenna and the second antenna).

In some embodiments, the direction component 240 may determine a direction of the source of the radio-frequency signal 260 or may determine the angle of arrival of the radio-frequency signal based on the phase difference. For example, the direction component 240 may use the equations (2) and (3) indicated above, to determine 6 (e.g., the angle of arrival of the radio-frequency signal 260 which may indicate the direction of the source of the radio-frequency signal or the angle of departure of the radio-frequency signal 260 from the source), based on the one or more of dielectric constant of the dielectric material 250 and the frequency (e.g., 800 megahertz, 1200 megahertz, or some other appropriate frequency) of the radio-frequency signal 260.

As discussed above, the dielectric material 250 may alter the radio-frequency signal 260 by reducing (e.g., decreasing) the propagation speed of the radio-frequency signal 260 by a determined amount (e.g., an amount determined based on the type of the dielectric material 250). In one embodiment, slowing down the propagation speed of the radio-frequency signal 260 (e.g., reducing or decreasing the propagation speed) using the dielectric material 260 may allow the computing device to increase directional resolution or the directional precision when determining the angle of arrival of the radio-frequency signal 260 (e.g., the angle of departure or the direction of the source of the radio-frequency signal 260) without increasing the distance between antennas in an antenna cluster (e.g., without increasing the distance between a first antenna and a second antenna). For example, with the appropriate dielectric material 250, the amount of distance between the first antenna and the second antenna may be reduced from twenty centimeters to two centimeters, while maintaining or improving the directional precision or directional resolution. This may allow the antenna cluster or computing device 110 to simulate or emulate a larger distance between the antennas 111 by slowing down the propagation speed of the radio-frequency signal using the dielectric material 260 (e.g., a solid dielectric material). This may also allow for a reduction in the size of antenna clusters which may allow the antenna cluster to be used in more types of devices and in more applications. In another embodiment, slowing down the propagation speed of the radio-frequency signal 260 using the dielectric material 250 may allow for better (e.g., improved) directional precision or directional resolution without increasing the size of an antenna cluster. For example, rather than increasing the size of an antenna cluster (e.g., increasing the distance between antennas) to improve directional precision or directional resolution, the appropriate dielectric material may be used.

FIG. 2C illustrates an example receiver component, in accordance with some embodiments of the present disclosure. The receiver component 270 is shown to include continuous-time signal processing 272, analog to digital converter (ADC) 274, phase estimator 276, and demodulator 278 all along a receive path 270. In an embodiment, the RF signal 270 enters the continuous-time signal processing 272 where it is filtered and mixed with the local oscillator signal 273 to down-convert the desired frequency (e.g., or channel) to an intermediate frequency. In an embodiment, the down-conversion process provides the intermediate frequency as complex I and Q signals which are sampled and digitized by the ADC 274. The phase estimator 276 may perform calculations to estimate the phase 277 of the RF signal 271 for the time it was received at the antenna using the I and Q values 275, and forward the phase value to the demodulator 278, which forwards the data 279 (e.g., the decoded sequence of 1s and 0s) for further processing (e.g., packet processing). The phase estimator 276 also forwards the phase 277 to the direction component 240 of FIG. 2B (e.g., or to a memory) for use in angle of arrival (AoA) estimation or determination, as described herein.

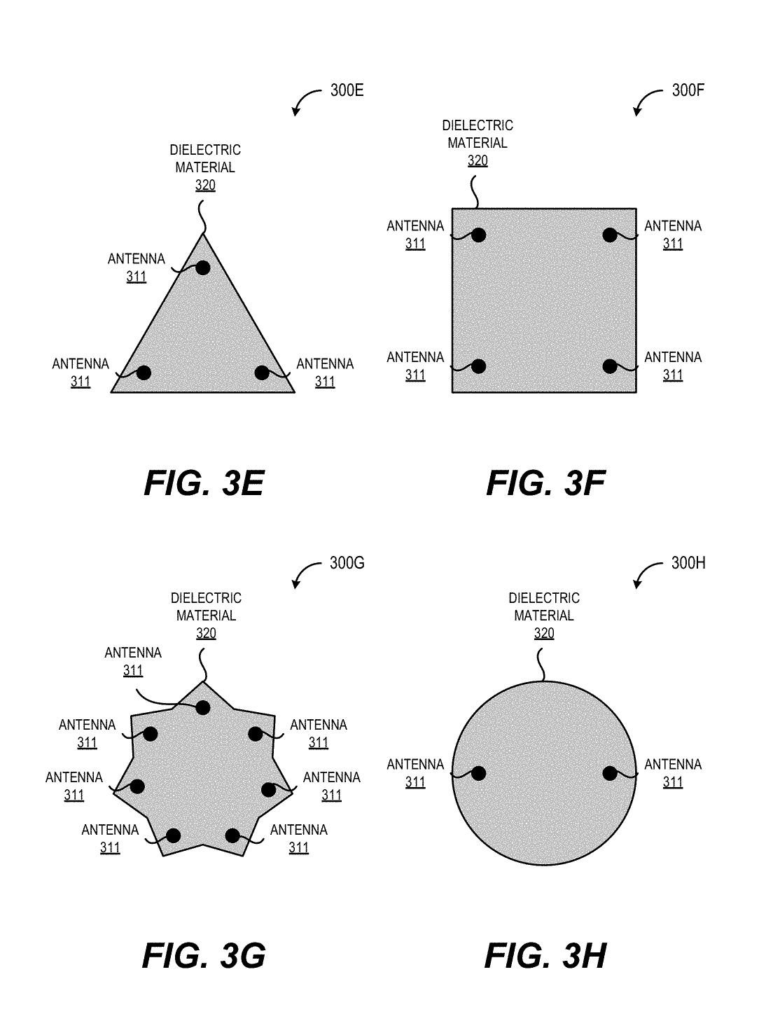

FIGS. 3A through 3H illustrate example antenna clusters, in accordance with some embodiments of the present disclosure. FIG. 3A illustrates a cross-section of an antenna cluster 300A. The antenna cluster 300A includes dielectric material 320 and three antennas 311. As illustrated in FIG. 3A, the dielectric material 320 has a triangular shape and the antennas 311 are disposed (e.g., located, placed, positioned, etc.) on the outside of the dielectric material 320 (e.g., one on each side of the triangle).

FIG. 3B illustrates a cross-section of an antenna cluster 300B. The antenna cluster 300B includes dielectric material 320 and four antennas 311. As illustrated in FIG. 3B, the dielectric material 320 has a square shape and the antennas 311 are disposed (e.g., located, placed, positioned, etc.) on the outside of the dielectric material 320 (e.g., one on each side of the square).

FIG. 3C illustrates a cross-section of an antenna cluster 300C. The antenna cluster 300C includes dielectric material 320 and three antennas 311. As illustrated in FIG. 3C, the dielectric material 320 has a star shape (e.g., a seven point star) and the antennas 311 are disposed (e.g., located, placed, positioned, etc.) on the outside of the dielectric material 320 (e.g., one on each concave vertex of the star).

FIG. 3D illustrates a cross-section of an antenna cluster 300D. The antenna cluster 300D includes dielectric material 320 and three antennas 311. As illustrated in FIG. 3D, the dielectric material 320 has a circular shape and the antennas 311 are disposed (e.g., located, placed, positioned, etc.) on the outside of the dielectric material 320 (e.g., one on each of the left and right side of the circle).

FIG. 3E illustrates a cross-section of an antenna cluster 300E. The antenna cluster 300E includes dielectric material 320 and three antennas 311. As illustrated in FIG. 3A, the dielectric material 320 has a triangular shape and the antennas 311 are disposed (e.g., located, placed, positioned, etc.) within the dielectric material 320 (e.g., one near each side of the triangle).

FIG. 3F illustrates a cross-section of an antenna cluster 300F. The antenna cluster 300F includes dielectric material 320 and four antennas 311. As illustrated in FIG. 3F, the dielectric material 320 has a square shape and the antennas 311 are disposed (e.g., located, placed, positioned, etc.) within the dielectric material 320 (e.g., one near each side of the square).

FIG. 3G illustrates a cross-section of an antenna cluster 300G. The antenna cluster 300G includes dielectric material 320 and three antennas 311. As illustrated in FIG. 3G, the dielectric material 320 has a star shape (e.g., a seven point star) and the antennas 311 are disposed (e.g., located, placed, positioned, etc.) within the dielectric material 320 (e.g., one near each convex vertex of the star).

FIG. 3H illustrates a cross-section of an antenna cluster 300H. The antenna cluster 300H includes dielectric material 320 and three antennas 311. As illustrated in FIG. 3H, the dielectric material 320 has a circular shape and the antennas 311 are disposed (e.g., located, placed, positioned, etc.) within the dielectric material 320 (e.g., one near each of the left and right side of the circle).

The shapes, orientations, sizes, of the dielectric material 320 and the locations of the antenna 311 illustrated in FIGS. 3A through 3H and described herein are non-limiting examples. In other embodiments, various shapes (e.g., geometric shapes, irregular shapes), orientations, sizes, of dielectric material 320 may be used, and any appropriate number of antennas 311 may be located in any appropriate place. For example, some antennas 311 may be located outside the dielectric material 320, some antennas 311 may be located within the dielectric material 320 (e.g., may be enclosed or encased in the dielectric material), and some antennas 311 may be partially enclosed or encased by the dielectric material 320. The shape of the dielectric material, the number of antennas, and the placement of the antennas (e.g., locations of one or more antennas along, inside, or partially inside a dielectric material) may be referred to as the geometry of the antenna cluster. The embodiments described herein may be applicable to various antenna clusters with different geometries.

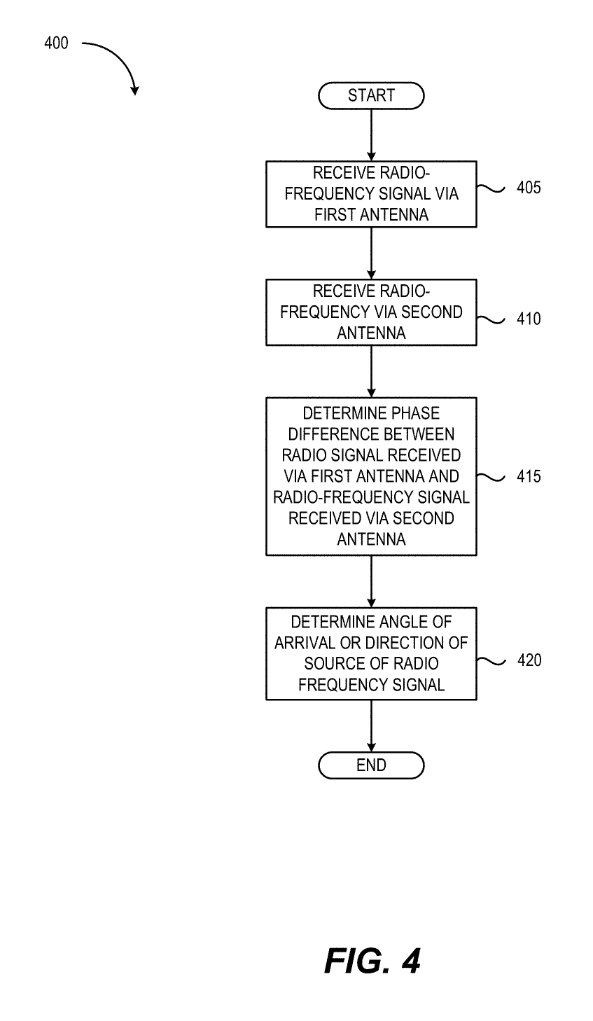

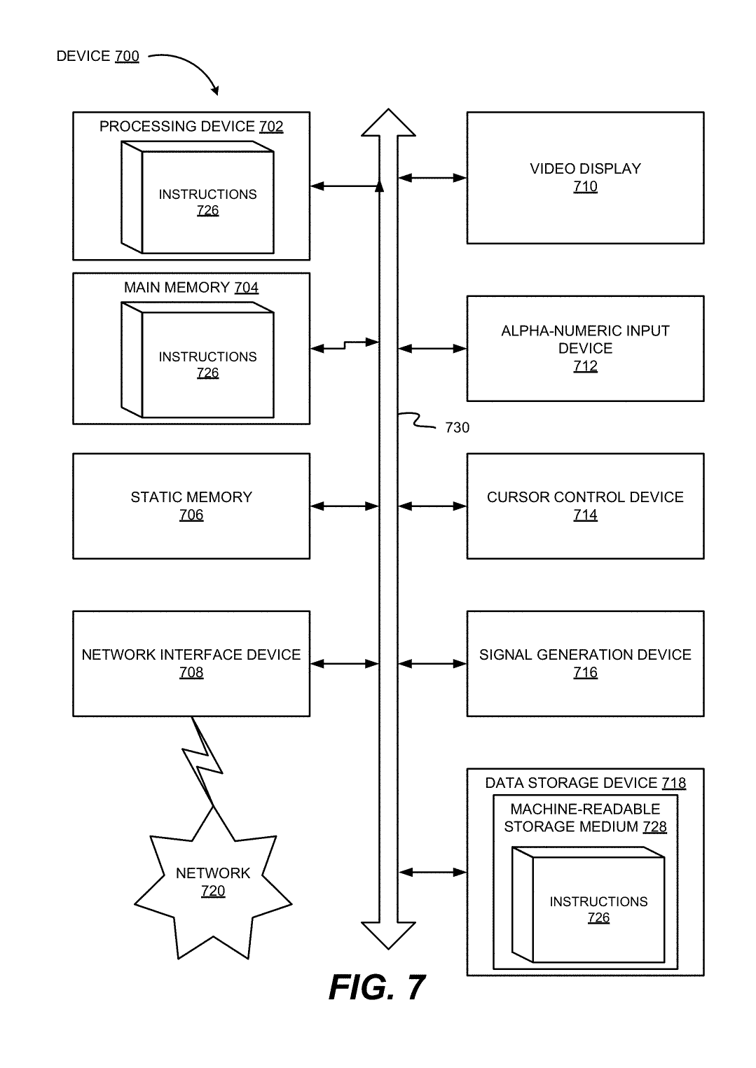

FIG. 4 is a flow diagram of a method 400 of determining an angle of arrival (e.g., an angle of departure or a direction of a source of the radio-frequency signal), according to some embodiments of the present disclosure. Method 400 may be performed by processing logic that may comprise hardware (e.g., circuitry, dedicated logic, programmable logic, a processor, a processing device, a central processing unit (CPU), a multi-core processor, a system-on-chip (SoC), etc.), software (e.g., instructions running/executing on a processing device), firmware (e.g., microcode), or a combination thereof. In some embodiments, the method 400 may be performed by a direction component (e.g., direction component 240 illustrated in FIG. 2B), a computing device (e.g., computing device 110 illustrated in FIG. 2B), or a processing device (e.g., processing device 702 illustrated in FIG. 7).

The method 400 begins at block 405, where the method 400 receives a radio-frequency signal via a first antenna. At block 410, the method 400 receives the radio-frequency signal via a second antenna. As discussed above, the first antenna may be located a first distance (e.g., an actual or physical distance) from the second antenna (e.g., may be located a millimeter a centimeter, or some other appropriate distance from the second antenna 111). In addition, a dielectric material with a dielectric constant, may be disposed (e.g., located) between the first antenna and the second antenna. The method 400 may determine a phase difference in the radio-frequency signal that is received by a first antenna and a second antenna at block 415. For example, the method 400 may determine the phase difference, based on one or more of the type of the dielectric material, the dielectric constant of the dielectric material, and the frequency of the radio-frequency signal, as discussed above. The dielectric material may alter the radio-frequency signal by reducing, decreasing, etc., the propagation speed of the radio-frequency signal by a determined amount (e.g., an amount determined based on the type of the dielectric material) as it passes through the dielectric material 250. At block 420, the method 400 may determine the angle of arrival of the direction of the source of the radio-frequency signal based on one or more of the dielectric constant, frequency of the radio-frequency signal, and the propagation speed reduction caused by the dielectric material, as discussed above.

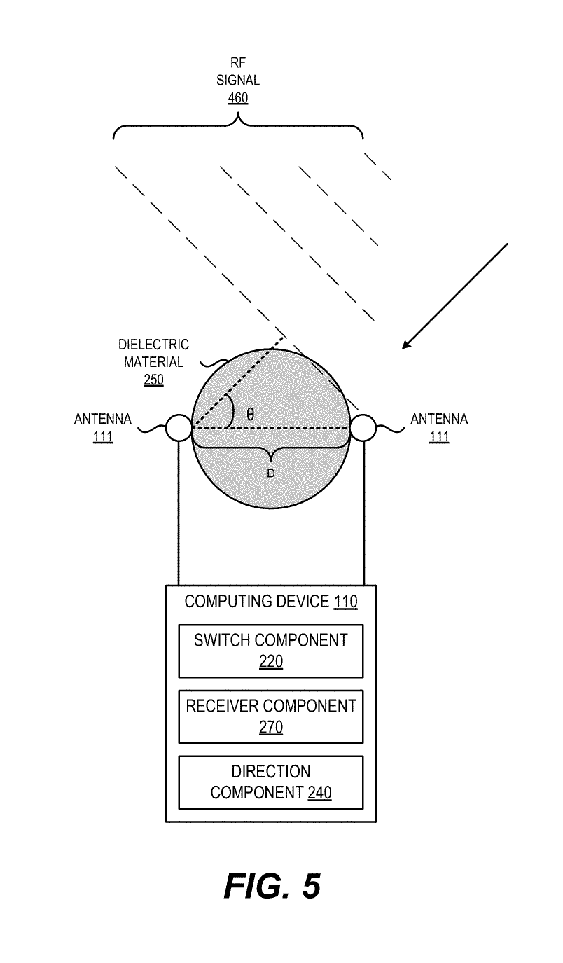

FIG. 5 illustrates an example computing device 110, in accordance with some embodiments of the present disclosure. As discussed above, the computing device 110 may communicate with other devices via a network, such as a wireless network (not illustrated in the figures). The network may carry communications to and from the computing device 110 via radio-frequency signals, as discussed above. The computing device includes a direction component 240. The direction component 240 may be hardware, software, firmware, or a combination thereof, that may determine the angle of arrival, angle of departure, or direction of a source of a radio-frequency signal, as discussed in more detail below.

As illustrated in FIG. 5, computing device 110 is coupled to two antennas 111 (e.g., an antenna cluster) located on opposite ends of a circular dielectric material 250. The two antennas 111 may be referred to as an antenna cluster. The two antennas 111 may be coupled to each other via switching or multiplexing components. The two antennas 111 may also be coupled to one or more receivers (e.g., radio receivers) via switching or multiplexing components. As discussed above, a device may communicate with the computing device 110 by transmitting a radio-frequency (RF) signal 460 to the computing device 110. The computing device 110 may receive the radio-frequency signal 460 via the two of antennas 111. The radio-frequency signal 460 may be transmitted to the computing device 110 as radio waves (illustrated by the dash lines of the radio-frequency signal 460). Examples of radio-frequency signal 460 may be Bluetooth signals, ZigBee signals, Wi-Fi signals, etc.

As discussed above, it may be useful for the computing device 110 to determine the direction of a source of the radio-frequency signal 460. Determining the direction of the source of the radio-frequency signal 460 may be referred to as determining the angle of arrival of the radio-frequency signal 460 at the computing device 110, or may be referred to as determining the angle of departure at the source of the radio-frequency signal 460. Also, as discussed above, equations (2) and (3) may be used to determine the angle of arrival of the radio-frequency signal 460.

In one example, if the dielectric material 250 is rubber (e.g., the type of the dielectric material 250 may be rubber), the distance D between the antennas 111 may be 47.2 millimeters (mm). The dielectric material 250 (e.g., rubber) may allow the computing device 110 to determine the direction of the radio-frequency signal with the same directional resolution or directional precision as two antennas that are spaced 125 mm apart without a solid dielectric between them (e.g., with air between the two antennas). Using rubber as the dielectric material 250 may result in a 2.65 times reduction in the size of the antenna cluster. In another example, if the dielectric material 250 is polyethylene (e.g., the type of the dielectric material 250 may be polyethylene), the distance D between the antennas 111 may be 83.4 millimeters (mm). The dielectric material 250 (e.g., polyethylene) may allow the computing device 110 to determine the direction of the radio-frequency signal with the same directional resolution or directional precision as two antennas that are spaced 125 mm apart without a solid dielectric between them (e.g., with air between the two antennas). Using polyethylene as the dielectric material 250 may result in a 1.5 times reduction in the size of the antenna cluster.

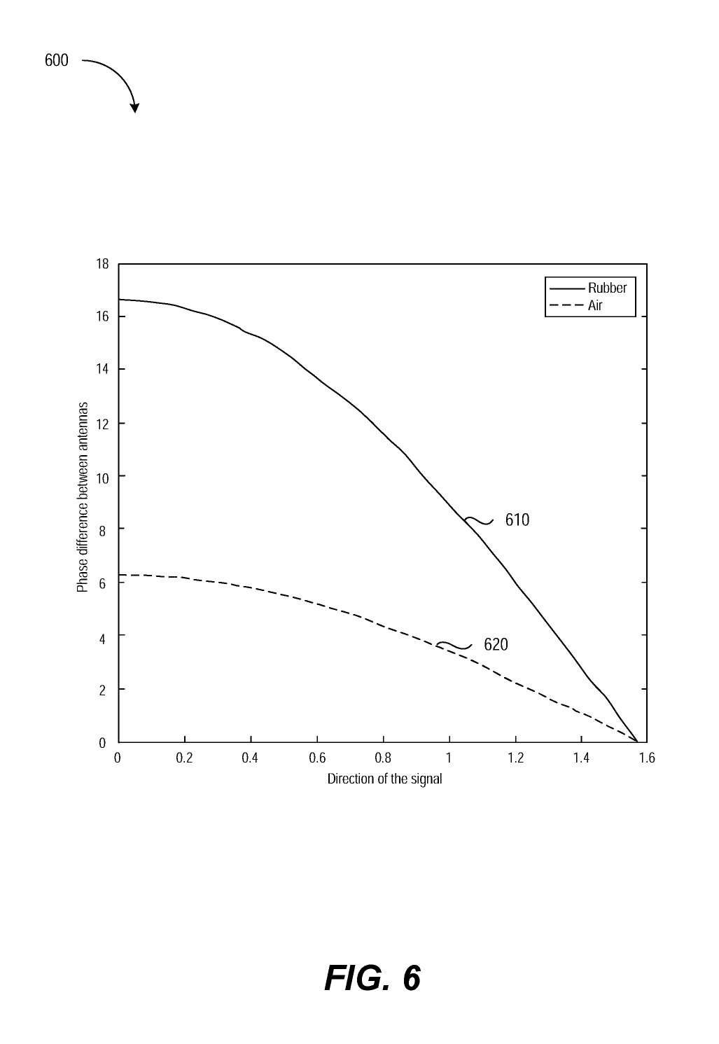

FIG. 6 is a graph 600 illustrating example phase differences in accordance with some embodiments of the present disclosure. In one embodiment, the phase differences illustrated in graph 600 may be detected by the antennas 111 illustrated in FIG. 5. The Y-axis of the graph 600 represents the phase difference that was detected between the two antennas that are spaced a distance D apart. The X-axis of the graph represents the angle or direction of the radio-frequency signal. The line 610 illustrates the phase differences detected by the two antennas (spaced 47.2 mm apart) at different angles or direction when rubber is used as the dielectric material. The line 620 illustrates the phase differences detected by the two antennas (spaced the distance 125 mm apart) at different angles or direction when no solid dielectric is used (e.g., when air is used). As illustrated in the graph 600, the rubber dielectric results in higher phase differences in the radio-frequency signal received by the two antennas.

FIG. 7 is a block diagram of an example device 700 that may perform one or more of the operations described herein, in accordance with some embodiments. Device 700 may be connected to other devices in a LAN, an intranet, an extranet, and/or the Internet. The device may operate in the capacity of a server machine in client-server network environment or in the capacity of a client in a peer-to-peer network environment. The device may be an electronic or computing device (such as a personal computer (PC), a tablet computer, a PDA, a smartphone, a set-top box (STB), a server computer, etc.), a network device (such as a router, switch or bridge), or any machine capable of executing a set of instructions (sequential or otherwise) that specify actions to be taken by that machine. Further, while only a single device is illustrated, the term “device” shall also be taken to include any collection of devices that individually or jointly execute a set (or multiple sets) of instructions to perform the methods discussed herein.

The example device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Device 700 may further include a network interface device 708 which may communicate with a network 720. The device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing instructions 726 for one or more of a direction component may also reside, completely or at least partially, within main memory 704 and/or within processing device 702 during execution thereof by device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “obtaining,” “transmitting,” “receiving,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions. The machine-readable medium may be referred to as a non-transitory machine-readable medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Also, the terms “first,” “second,” “third,” “fourth,” etc., as used herein are meant as labels to distinguish among different elements and may not necessarily have an ordinal meaning according to their numerical designation. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. An apparatus, comprising:
a first antenna configured to receive a radio-frequency signal;
a second antenna configured to receive the radio-frequency signal, wherein the second antenna is located a first distance away from the first antenna;
a solid dielectric material disposed between the first antenna and the second antenna, wherein the solid dielectric is configured to alter the radio-frequency signal to simulate a second distance between the first antenna and the second antenna; and
a computing device comprising a processing device and an analog-to-digital converter (ADC), wherein the processing device is communicatively coupled to the first antenna and the second antenna, the processing device to:
convert, by the ADC, the radio frequency signal received by the first antenna into a first digital signal and the radio frequency signal received by the second antenna into a second digital signal;
determine a phase difference between the first digital signal and the second digital signal, based on the second distance, wherein the second distance is based on a type of the solid dielectric material; and
determine a direction of a source of the radio-frequency signal relative to the apparatus, with a directional resolution of a set of antennas that are spaced the second distance apart, based on the phase difference.

2. The apparatus of claim 1, wherein the second distance is larger than the first distance.

3. (canceled)

4. The apparatus of claim 1, wherein to determine the direction of the source of the radio-frequency signal, the processing device is further to:
determine an angle of arrival of the radio-frequency signal based on the phase difference.

5. The apparatus of claim 1, wherein the solid dielectric material is configured to alter the radio-frequency signal by reducing a propagation speed of the radio-frequency signal.

6. The apparatus of claim 5, wherein reducing the propagation speed of the radio-frequency signal simulates the second distance between the first antenna and the second antenna.

7. The apparatus of claim 1, further comprising:
a third antenna configured to receive the radio frequency signal, wherein the third antenna is located a third distance away from the first antenna and wherein the processing device is further configured to determine a second phase difference between the radio frequency signal received by the first antenna and the radio frequency signal received by the third antenna, based on the third distance, wherein the third distance is based on the type of the solid dielectric material.

8. The apparatus of claim 1, wherein the phase difference is determined further based on a dielectric constant of the solid dielectric material.

9. The apparatus of claim 1, wherein the phase difference is determined further based on a frequency of the radio-frequency signal.

10. An apparatus, comprising:
a computing device comprising a processing device and an analog-to-digital converter (ADC);
a first antenna configured to receive a radio-frequency signal;
a second antenna configured to receive the radio-frequency signal, wherein the second antenna is located a first distance away from the first antenna; and
a solid dielectric material disposed between the first antenna and the second antenna, wherein the solid dielectric material is configured to simulate a second distance between the first antenna and the second antenna by reducing a propagation speed of the radio-frequency signal by a determined amount to allow the ADC to convert the radio frequency signal received by the first antenna into a first digital signal and the radio frequency signal received by the second antenna into a second digital signal and allow the processing device to determine a phase difference between the first digital signal and the second digital signal, based on the second distance and to determine a direction of a source of the radio-frequency signal relative to the apparatus, with a directional resolution of a set of antennas that are spaced the second distance apart, based on the phase difference.

11. The apparatus of claim 10, wherein reducing the propagation speed of the radio-frequency signal simulates a first distance between the first antenna and the second antenna.

12. The apparatus of claim 11, wherein reducing the propagation speed of the radio-frequency signal provides angle of arrival information for the radio-frequency signal.

13. The apparatus of claim 10, wherein the determined amount is based on a dielectric constant of the solid dielectric material.

14. The apparatus of claim 10, wherein the determined amount is based on a frequency of the radio-frequency signal.

15. A method, comprising:
receiving a radio-frequency signal via a first antenna;
receiving the radio-frequency via a second antenna, wherein:
the second antenna is located a first distance from the first antenna; and
a solid dielectric material is disposed between the first antenna and the second antenna, wherein the solid dielectric material is configured to alter the radio-frequency signal to emulate a second distance between the first antenna and a second antenna;
converting, by an analog-to-digital converter (ADC), the radio frequency signal received by the first antenna into a first digital signal and the radio frequency signal received by the second antenna into a second digital signal;
determining a phase difference between the first digital signal and the second digital signal, based on the second distance, wherein the second distance is based on a type of the solid dielectric material; and
determining a direction of a source of the radio-frequency signal relative to an apparatus, with a directional resolution of a set of antennas that are spaced the second distance apart, based on the phase difference.

16. The method of claim 15, wherein the second distance is larger than the first distance.

17. (canceled)

18. The method of claim 15, wherein determining the direction of the source of the radio-frequency signal comprises:
determining an angle of arrival of the radio-frequency signal based on the phase difference.

19. The method of claim 15, wherein the solid dielectric material is configured to alter the radio-frequency signal by reducing a propagation speed of the radio-frequency signal.

20. The method of claim 19, wherein reducing the propagation speed of the radio-frequency signal simulates the second distance between the first antenna and the second antenna.
